(19) United States
(12) Patent Application Publication
(10) Pub. No.: US 2010/0193319 A1
(43) Pub. Date: Aug. 5, 2010

(54) TRANSMISSION

(75) Inventors: Klaus-Jürgen STUTZER, Wiesbaden (DE); Patrick BARTH, Plobsheim (FR); Arnaud OTT, Diebolsheim (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/698,820

(22) Filed: Feb. 2, 2010

(30) Foreign Application Priority Data
Feb. 2, 2009 (GB) 0901723.7

(51) Int. Cl. F16H 61/22

(52) U.S. Cl. 192/219.5

(57) ABSTRACT

A transmission is provided with a park pawl moveable around an axis and positioned over a park gear. An actuator assembly is provided for pushing the park pawl against the effect of a return spring in a blocked position thus blocking the park gear. In order to provide a transmission in which the risk of an erroneous engagement of the park pawl due to a broken spring is avoided, means, such as a mechanical coupling, are provided for mechanically coupling the park pawl to the actuator when the park pawl is in unblocked position. Due to this mechanical coupling, the park pawl is retained in the unblocked position and prevented from falling into the park gear even if the return spring breaks.

### CROSS-REFERENCE TO RELATED APPLICATION

This application claims priority to British Patent Application No. 0901723.7, filed Feb. 2, 2009, which is incorporated herein by reference in its entirety.

### TECHNICAL FIELD

The invention concerns a transmission with a park pawl moveable around an axis and being positioned over a park gear, an actuator assembly being provided for pushing the park pawl against the effect of a return spring in its blocked position thus blocking the park gear. It also concerns a process for controlling a transmission configured in that way.

### BACKGROUND

The park pawl cooperating with the park gear assures that a vehicle with automatic transmission is blocked when the gear selection lever is in position “P”. The park pawl has the form of a lever with a tooth at its free end which can engage with the teeth of the park gear of the transmission in order to block the vehicle. The park pawl is moveable around an axis and the return spring which may be fixed both on the park pawl and the housing of the transmission retains the park pawl in its unblocked position. An actuator assembly consisting of an actuator displaceable by the means of a detent lever fixed at its first end and provided with a protrusion at its other end actions the park pawl. When the detent lever pushes the actuator forwards, the protrusion is pushed by an actuator bracket towards the end of the park pawl until it engages with the park gear teeth. Upon moving the actuator backwards, the park pawl is disengaged from the park gear due to the effect of the return spring.

Currently, the park pawl is positioned over the park gear and is pushed downwards by the actuator assembly to enter into contact with the park gear. In this case, gravity could engage the park pawl into the park gear if the return spring breaks. This might cause serious accidents and represents a severe security issue.

It is therefore the at least one objective of the present invention to provide a transmission in which the risk of an erroneous engagement of the park pawl due to a broken spring is avoided. In addition, other objectives, desirable features, and characteristics will become apparent from the subsequent summary and detailed description, and the appended claims, taken in conjunction with the accompanying drawings and this background.

### SUMMARY

This at least one objective, other objectives, desirable features, and characteristics are achieved according to an embodiment of the present invention in that means are provided for mechanically coupling the park pawl to the actuator when the park pawl is in unblocked position.

Due to this mechanical coupling, the park pawl is retained in the unblocked position and prevented from falling into the park gear even if the return spring breaks.

In a preferred embodiment of the invention, the actuator is provided at its free end with a lever which engages with a protrusion of the park pawl when the actuator is moved backwards thus holding the park pawl over the park gear.

The protrusion should be placed near to the free end of the park pawl in order to be able to prevent the park pawl from falling down into the park gear.

The embodiments of the invention also concern a process for controlling a transmission with a park pawl moveable around an axis and being positioned over a park gear, an actuator assembly being provided for pushing the park pawl against the effect of a return spring in its blocked position thus blocking the park gear, in which the park pawl is mechanically coupled to the actuator when the park pawl is in unblocked position.

According to a preferred embodiment of this process, a lever situated at the free end of the actuator engages with a protrusion of the park pawl when the actuator is moved backwards thus holding the park pawl over the park gear.

### BRIEF DESCRIPTION OF THE DRAWINGS

The present invention will hereinafter be described in conjunction with the following drawing figures, wherein like numerals denote like elements, and

FIGS. 1a to 1d show a device according to the prior art in side view in its blocked position and in side view, in front view and in rear view in its unblocked position;

FIGS. 2a to 2d show a first device according to an embodiment of the present invention in side view in its blocked position and in side view, in front view and in rear view in its unblocked position; and

FIGS. 3a to 3d show a second device according to an embodiment of the present invention in side view in its blocked position and in side view, in front view and in rear view in its unblocked position.

### DETAILED DESCRIPTION

The following detailed description is merely exemplary in nature and is not intended to limit application and uses. Furthermore, there is no intention to be bound by any theory presented in the preceding background or summary or the following detailed description.

Park and out of park positions of the vehicle are given by the actuator position. This position is driven through the transmission external lever by the vehicle external shifter (“P” for “Park” and R, N, D for “Out of Park”).

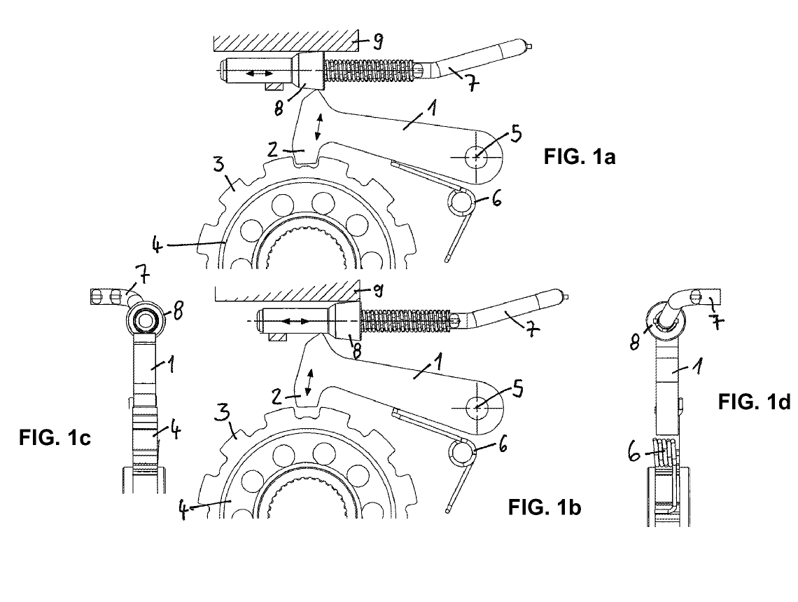

As shown in FIGS. 1a and 1b, the park pawl 1 according to the prior art has the form of a lever with a tooth 2 at its free end which can engage with the teeth 3 of the park gear 4 of the transmission in order to block the vehicle. The park pawl 1 is moveable around an axis 5 and a return spring 6 retains the park pawl 1 in its unblocked position. An actuator assembly consisting of an actuator 7 displaceable by the means of a detent lever (not shown) fixed at its first end and provided with a protrusion 8 at its other end actions the park pawl 1. When the detent lever pushes the actuator 7 forwards (FIG. 1a), the protrusion 8 is pushed by an actuator bracket 9 towards the end of the park pawl 1 until it engages with the park gear teeth 3. Upon moving the actuator 7 backwards (FIG. 1b), the park pawl 1 is disengaged from the park gear 4 due to the effect of the return spring 6.

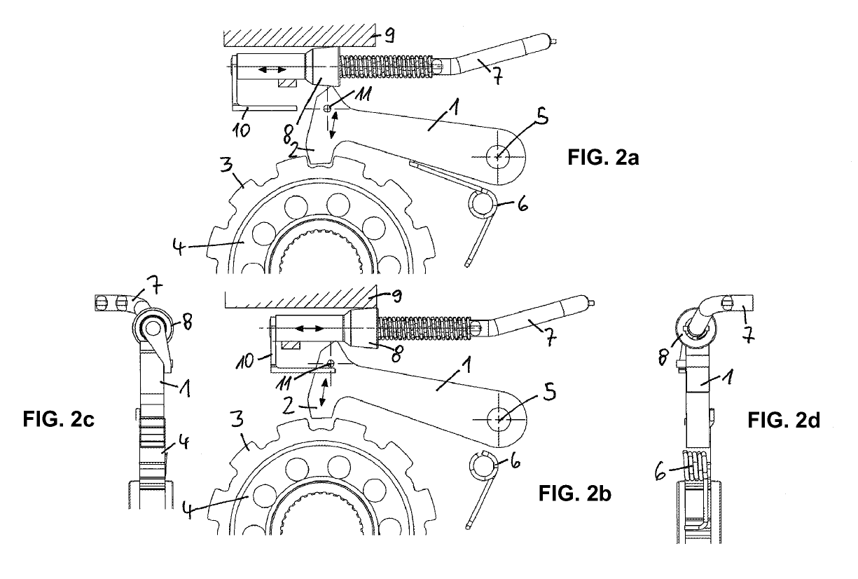

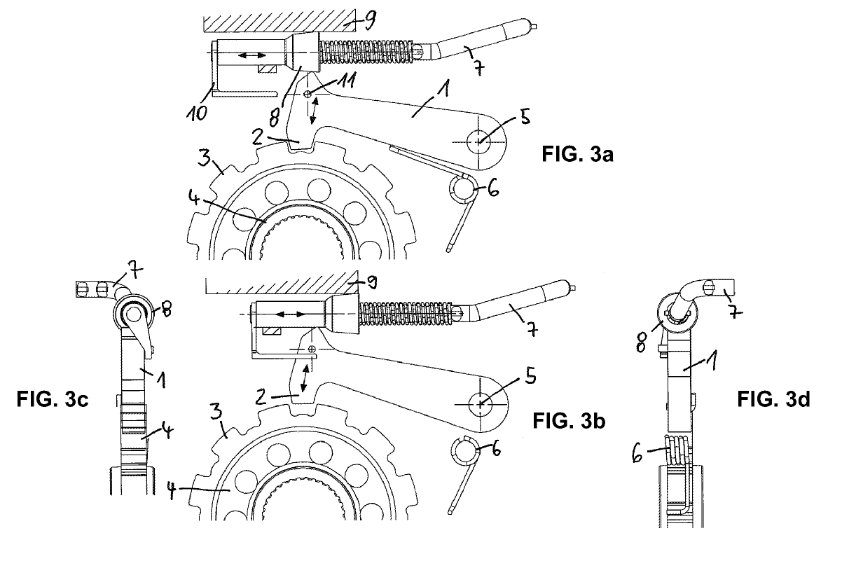

In such a case where the park pawl 1 is positioned over the park gear, gravity could engage the park pawl 1 into the park gear if the park pawl return spring 6 breaks. The mechanism shown in FIGS. 2a to 2d and 3a to 3d inhibits the park pawl 1 to fall into the park gear teeth 3 in such a case due to a mechanical lock system.

As represented in FIGS. 2a to 2d as well as in FIGS. 3a to 3d, the actuator 7 is provided at its free end with a lever 10 which engages with a protrusion 11 of the park pawl 1 when the actuator 7 is moved backwards so that it holds the park pawl 1 over the park gear 4 even if the return spring 6 has broken. The lever 10 is L-shaped, the vertical leg of the L being fixed to the end of the actuator 7 and the horizontal leg extending towards the protrusion 11 of the park pawl 1.

The protrusion 11 of the park pawl 1 is placed near to the free end of the park pawl 1 in order to be able to prevent the park pawl 1 from falling down into the park gear 4. It is to be noted that the lever 10 disengages from the protrusion 11 of the park pawl 1 when the actuator 7 is moved forwards releasing the park pawl 1 which can fall into the park gear 4 thereby blocking the transmission.

The device shown in FIGS. 2a to 2d differ from FIGS. 3a to 3d in that FIGS. 2a to 2d show an in line actuator 7, whereas FIGS. 3a to 3d show a cross actuating system.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A transmission, comprising:
a park gear;
a park pawl adapted to move around an axis and positioned over the park gear;
an actuator assembly adapted to push the park pawl against an effect of a return spring in a blocked position thus blocking the park gear; and
a mechanical coupling adapted to couple the park pawl to the actuator assembly when the park pawl is in an unblocked position.

2. The transmission according to claim 1, further comprising a lever at a free end of the actuator assembly that engages with a protrusion of the park pawl when the actuator assembly is moved backwards, thus holding the park pawl over the park gear.

3. A process for controlling a transmission, comprising the steps of:
adapting a park pawl to move around an axis;
positioning the park pawl over a park gear;
pushing the park pawl with an actuator assembly against an effect of a return spring in a blocked position thus blocking the park gear; and
mechanically coupling the park pawl to the actuator assembly when the park pawl is an unblocked position.

4. The process of claim 3, further comprising the step of engaging a lever situated at a free end of the actuator assembly with a protrusion of the park pawl when the actuator assembly is moved backwards, thus holding the park pawl over the park gear.
